(19) United States
(12) Patent Application Publication
(10) Pub. No.: US 2016/0249231 A1
(43) Pub. Date: Aug. 25, 2016

(54) METHOD AND SYSTEM FOR OPTIMIZING WIRELESS NETWORKS THROUGH FEEDBACK AND ADAPTATION

(71) Applicant: Honeywell International Inc., Morristown, NJ (US)

(72) Inventors: Kartik B. Ariyur, West Lafayette, IN (US); Srivatsan Varadarajan, St. Louis Park, MN (US); Yunjung Yi, Glendale, AZ (US)

(21) Appl. No.: 14/628,903

(22) Filed: Feb. 23, 2015

Related U.S. Application Data
(62) Division of application No. 11/857,748, filed on Sep. 19, 2007, now abandoned.
(60) Provisional application No. 60/927,414, filed on May 3, 2007.

(51) Int. Cl. H04W 24/02; H04L 12/26; H04W 24/08; H04L 12/24

(52) U.S. Cl. CPC H04W 24/02; H04L 41/145; H04L 41/0816; H04L 43/0852; H04L 43/0888; H04L 43/0829; H04W 24/08; H04W 84/12

(57) ABSTRACT

A method for optimizing a wireless network comprises obtaining local measurement and feedback data from a single node in the network; estimating a state of the node by using the local measurement and feedback data in an analysis framework model of the wireless network; applying the estimated state of the node to a local control law to determine one or more local protocol parameter updates for the node; and transmitting the one or more local protocol parameter updates to the node in the network.

This application is a divisional of U.S. application Ser. No. 11/857,748, filed on Sep. 19, 2007, which claims the benefit of priority to U.S. Provisional Application No. 60/927,414, filed on May 3, 2007, the disclosures of which are incorporated by reference.

The U.S. Government may have certain rights in the present invention as provided for by the terms of Contract No. W911NF-06-3-0001 (International Technology Alliance sponsored by the U.S. Army Research Laboratory and the U.K. Ministry of Defense).

### BACKGROUND

Wireless networks, such as those running the IEEE 802.11 Media Access Control (MAC) protocol, are generally optimized for specific operating conditions and are not customized to specific applications. Hence, the full capacity of such networks is unusable for most conditions.

An underlying problem in multi-hop wireless ad hoc networks is quality of service (QoS) provisioning, which is very challenging due to the interference and contention-based nature of wireless networks. In such networks, a node has to contend with other nodes to obtain transmission opportunities, not to mention the mobility dynamics and environment effects. This problem is compounded further because of the inability to cleanly and analytically characterize dynamics of a Network Routing Protocol composed in conjunction with an underlying MAC protocol.

While there have been many studies on capacity estimation of wireless networks that offer insights on capacity limits, these studies tend to be asymptotic analyses and not conducive for use in terms of adapting application QoS, i.e., achievable and transport usable capacity. In addition, some existing analytical models on wireless network capacity analysis study the throughput of IEEE 802.11 networks under saturation cases, wherein each node has immediately a packet ready for transmission after the completion of each successful transmission. This saturation assumption helps in keeping the data collision probability high and at a constant level. While this assumption makes analysis tractable, it is not realistic where networks are not saturated and in fact adapted suitably to maintain adequate capacity available for other applications.

Other studies have explicitly ignored hidden terminal effects or do not fully characterize the impacts resulting from the traffic in hidden nodes. Still other studies assume perfect scheduling whereby a node can transmit traffic when it senses no other traffic is interfering with it, or assume specific distribution of traffic arrival like Poisson, or assume existence and solve for stationary (long-term stable property) distribution of MAC service time which is non-conducive for evaluation of short-term behavior of the MAC.

In another study, a memory-less property was assumed between renewal points where a renewal point is defined as an instance when there is successful transmission and/or a collision, which is not the case when there are hidden terminals. This is because the maximum contention window is doubled after each request-to-send/data collision and the back off periods are dependent and cannot be viewed as a renewal process.

A more recent study derived an analytical model taking the effects from both the carrier sense traffic and those from the hidden terminal traffic into account. Moreover, different traffic conditions (both saturated and unsaturated) are also addressed in the model and the analysis is extended to a path capacity analysis. However, this study does not analytically incorporate the queue waiting time for a packet before it gets serviced by the MAC layer into its computations. While this model is good when the sizes of network queues are low and when the network is lightly loaded, it does not extend well to the case when the network is heavily loaded and the dominating service times are because of wait times in the network queue.

### SUMMARY

The present invention relates to a method and system for wireless network optimization. The method comprises obtaining local measurement and feedback data from a single node in the wireless network; estimating a state of the node by using the local measurement and feedback data in an analysis framework model of the wireless network; applying the estimated state of the node to a local control law to determine one or more local protocol parameter updates for the node; and transmitting the one or more local protocol parameter updates to the node in the wireless network. The method can further comprise obtaining global measurement and feedback data from one or more additional nodes in the wireless network; estimating a state of the one or more additional nodes by using the global measurement and feedback data in the analysis framework model; applying the estimated state of the one or more additional nodes to the local control law; applying the estimated state of the one or more additional nodes to a global control law to determine one or more network-wide protocol parameter updates; and transmitting the network-wide protocol parameter updates to the wireless network.

### BRIEF DESCRIPTION OF THE DRAWINGS

Features of the present invention will become apparent to those skilled in the art from the following description with reference to the drawings. Understanding that the drawings depict only typical embodiments of the invention and are not therefore to be considered limiting in scope, the invention will be described with additional specificity and detail through the use of the accompanying drawings, in which:

FIG. 1 is a schematic configuration of a wireless network showing application traffic over the network;

FIG. 2 is a schematic diagram of a finite state machine from a transmission perspective;

FIG. 3 is a schematic diagram of network queue behavior for transmission of a packet from a first node to a second node in the network;

FIG. 4 is a schematic diagram of an adaptation framework system for network optimization;

FIG. 5 is a schematic diagram of a network adaptation system for network optimization;

FIG. 6 is a schematic diagram of a node scenario for a network validation test;

FIGS. 7A and 7B are graphs showing simulation test results for extremum seeking performance; and

FIG. 8 is a graph showing performance results of a real-time adaptation framework.

### DETAILED DESCRIPTION

In the following detailed description, embodiments are described in sufficient detail to enable those skilled in the art to practice the invention. It is to be understood that other embodiments may be utilized without departing from the scope of the present invention. The following detailed description is, therefore, not to be taken in a limiting sense.

The present invention relates to a method and system for enhancing performance of wireless networks through feedback and adaptation. The present method and system provide for capacity maximization and loss minimization in optimizing wireless networks.

The invention includes an analytic framework model for computing network capacity for IEEE 802.11 networks that can be generalized to many other kinds of wireless networks. The analytic framework allows schemes for feedback and adaptation to change protocol parameters to provide better performance to the traffic loads imposed. Some of the adaptation schemes use the analytical framework model, but others do not depend upon the model.

The analytic framework also provides for transport capacity conducive for QoS adaptation in an 802.11b and a multi-hop routing protocol network. The invention also provides an adaptive framework that can be used in a static wireless network such as a sensor network to tune network parameters at the time of new unicast flow admission into the network. The adaptive framework is based on a genetic algorithm and an extremum seeking algorithm in a sensor network that considerably enhances the network throughput.

The invention addresses the underlying problem of Quality of Service (QoS) provisioning in multi-hop wireless ad hoc networks which is very challenging due to the interference and contention-based nature of wireless networks. In such networks, a node has to contend with other nodes to obtain transmission opportunities, not to mention the mobility dynamics and environment effects. This problem is compounded further because of the inability to cleanly and analytically characterize dynamics of a Network Routing Protocol composed in conjunction with an underlying MAC protocol.

The present invention addresses this problem in the context of a Carrier Sense Multiple Access (CSMA) protocol like IEEE 802.11b MAC protocol. The 802.11b protocol is used because a CSMA system, unlike TDMA systems, does not suffer the criticism that it requires expensive clock/time synchronization and perfect scheduling. In addition, the 802.11b protocol has become the de-facto standard for Wireless Local Area Networks (WLANs) and its applications have found space in community meshes which aim to provide the last-mile broadband Internet access.

The invention considers QoS adaptation at the time of new unicast (single source, single destination) flow admission into the network. Some limited topology dynamics is assumed, whereby the multi-hop routes are known apriori and static during the time of admission of flow, i.e., topology change because of node mobility and/or adapting the transmission power levels (and hence the data rates of 802.11n networks) happens at a larger time scale than the time scale at which flows are admitted to the network. As a result, routing paths can be pre-calculated and known in advance. This framework is useful where the node mobility dynamics (e.g., convoy of moving vehicles) are limited, and in particular static settings like wireless sensor networks. The framework can also be used in mobile ad hoc networks or wireless local area networks (LAN).

The following sections describe in more detail: a) an application centric view; b) a network centric view; c) an analytic framework for transport capacity conducive for QoS adaptation in a 802.11b and a multi-hop routing protocol network; and d) a practical adaptation framework based on a genetic algorithm and an extremum seeking algorithm in a sensor network that considerably enhances the network throughput.

### Application Centric View

The following items (under headings A and B) are assumed to be known apriori and static (unchanged) during the course of evaluation of the present invention.

A. Multi-Hop Network Model

A multi-hop routed IEEE 802.11 network is modeled as a graph G=(V, E) where Vis the set of nodes and E is the edge set consisting of directed links. A tuple is denoted (v₁, v₂)∈ E when there is a directed link from v₁ to v₂ where v1, v2 ∈ V. It should be noted that this implicitly assumes that the transmission and interference range from the RF perspective is given and fixed. That is, assume for the moment the power levels, coding and associated data rate available on the link (801.11 specifies 3 settings of 1, 2, and 11 Mbps) cannot be changed.

A path Path(s, d) in G(V, E) for some s, d ∈ V denotes a set of concatenated links given by Path(s, d)={(rᵢ₋₁, rᵢ) ∈ E, 0≦i≦n,r₀=s, rₙ=d}. It is assumed that all unicast routes, given by {Path(s,d), ∀ s, d ∈ V, s≠d}, are known and static. This routing table is constructed through some routing protocol like AODV, DSR or OLSR and the actual data is forwarded using this routing table. It is also assumed that the graph is connected.

B. Traffic and Buffering/Relaying Model

The average traffic rate on a path between a source s and destination d is denoted as A (s,d) packets/second and the size of all packets is denoted as μbits/packet. Fixed packet sizes are assumed for all traffic injected onto the network. Thus, λ(s, d).μ is the average transport capacity in bits/second. All traffic is unicast traffic. Note that no apriori distribution is assumed about traffic rate, except in so far that there is a first order moment, i.e., average. Each node has a buffer which is used to service both packets originating from that node as well as relaying/forwarding packets based on the routing path. The buffer is used as a temporary storage for a packet to wait its turn to be transmitted by the node. This buffer is serviced in first-in-first-out (FIFO) order and has INF buffer size. Thus, any packet would have to undergo a queuing delay as it traverses through each node.

C. Application Traffic Formulation

The transport packet rate (in packets/sec) of a link (v₁,v₂)∈ E is the reciprocal of the average transport service time, T^{S}(v₁,v₂), which is the average duration taken by v₁ to successfully transmit a data packet to v₂ correctly or eventually discard the data with average packet loss ratio P^{L}(v₁,v₂). Together, the transport QoS of a link determined by these two variables T^{R}(v₁,v₂)and P^{L}(v₁,v₂) and its analytical computation is employed in the method of the invention.

Intuitively, the available transport packet rate between a source s and a destination d is the maximum traffic rate that can be added to all links in Path(s,d) without violating any constraints of existing QoS on any link. The variables below are tagged with “old” to denote the state before addition of the traffic and “new” to denote the state after the addition of the new traffic.

The Maximum Available Packet Rate (MAPR) between source s and destination d, denoted by MAPR(s,d), is the problem of adding a new traffic A between them, i.e., λ^{new}(s,d)=λ^{old}(s,d)+λ and λ^{new}(v₁,v₂)=λ^{old}(v₁,v₂)+λ, ∀(v₁,v₂)∈ Path(s,d),

$$\begin{matrix}Max & ( λ ) & ( 1 ) \\ < 1 > & {λ}^{new} ( {v}_{1} , {v}_{2} ) \geq {λ}^{old} ( {v}_{1} , {v}_{2} ) , & ∀ ( {v}_{1} , {v}_{2} ) ∈ E ⋀ \\ & & ( {v}_{1} , {v}_{2} ) ∉ Path ( s , d ) \\ < 2 > & {λ}^{new} ( {v}_{1} , {v}_{2} ) \geq {λ}^{old} ( {v}_{1} , {v}_{2} ) + λ , & ( {v}_{1} , {v}_{2} ) ∈ Path ( s , d ) \\ < 3 > & {P}^{L} ( {v}_{1} , {v}_{2} ) < {P}_{maxloss} , & ∀ ( {v}_{1} , {v}_{2} ) ∈ E \\ < 4 > & {λ}^{new} ( {v}_{1} , {v}_{2} ) \leq \frac{1}{{T}^{s} ( {v}_{1} , {v}_{2} )} , & ∀ ( {v}_{1} , {v}_{2} ) ∈ E .\end{matrix}$$

To reiterate, the key to solving (1) is to derive/compute the average service time T^{s}(v₁,v₂) and packet loss ratio P^{L}(v₁,v₂) of a link (v₁,v₂). Pₘₐₓₗₒₛₛ is a constant parameter for the optimization and refers to an acceptable packet loss ratio for any traffic. It should be noted that the formulation tries to find a feasible A transport packet rate pipe through all transport links (v₁,v₂) ∈ Path(s,d) without affecting all the old traffic. It is also clear that the new traffic addition A becomes infeasible when ∃(v₁,v₂) ∈ Path(s,d) where there is a violation of constraint <3> or <4>, i.e., packet loss rate becomes too high (unacceptable) or service times become too high. This formulation can be used to define the minimal notion of transport capacity along a pathway that is needed, and can be used by any Application QoS adaptation scheme.

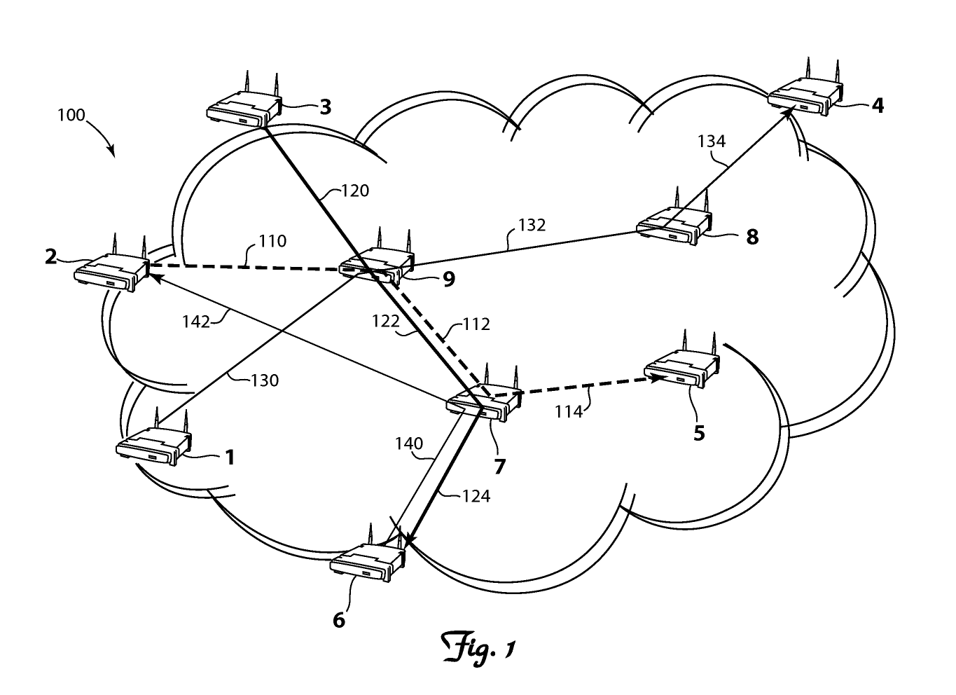

FIG. 1 is an exemplary schematic configuration of application traffic over a network 100 that implements the above formulation. The network 100 includes a plurality of wireless nodes 1-9 that are in operative communication with each other. Various pathways (s, d) are shown with links between nodes. For example, pathway (2, 5) has a link 110 between nodes 2 and 9, a link 112 between nodes 9 and 7, and a link 114 between nodes 7 and 5. The present approach is used to measure the available bandwidth X in a particular pathway. For example, the links 110, 112, and 114 have added to old traffic on the transmission side of these links, which is represented by the following constraints:

$${λ}^{new} {( 2 , 5 ) = {λ}^{old}}_{Solved and \\ Decomposed as} ( 2 , 5 ) + λ$$

$$\vec{{λ}^{new} ( 2 , 9 ) = {λ}^{old} ( 2 , 9 )} + λ , \\ {λ}^{new} ( 9 , 7 ) = {λ}^{old} ( 9 , 7 ) + λ , \\ {λ}^{new} ( 7 , 5 ) = {λ}^{old} ( 7 , 5 ) + λ .$$

Other pathways include pathway (3, 6) having a link 120 between nodes 3 and 9, a link 122 between nodes 9 and 7, and a link 124 between nodes 7 and 6; pathway (1, 4) has a link 130 between nodes 1 and 9, a link 132 between nodes 9 and 8, and a link 134 between nodes 8 and 4; pathway (6, 2) has a link 140 between nodes 6 and 7, and a link 142 between nodes 7 and 2. These pathways can be represented by the following constraints:

λ^{new}(3, 6)=λ^{old}(3, 6)+λ,

λ^{new}(1, 4)=λ^{old}(1, 4)+λ,

λ^{new}(6, 2)=λ^{old}(6, 2)+λ.

Each of these constraints can be solved and decomposed in a similar fashion as described above for pathway (2, 5) to determine the available bandwidth in a given pathway from end to end.

### Network Centric View

The present analytic framework primarily computes the performance impact of the MAC layer and the Network Layer.

A. MAC Layer Protocol

The following discussion focuses on the IEEE 802.11b version of the MAC layer protocol, with particular attention to its multi-rate feature that allows raw transmission rates of 1, 2, 5.5 and 11 Mbit/s by using different codes and modulations. The distributed coordination function (DCF) access method is utilized, which corresponds to the ad hoc functionality and allows two medium access mechanisms: basic access and collision avoidance (Request to Send (RTS)/Clear to Send (CTS)).

In the basic access method, a data frame could be corrupted by transmissions due to nodes that are hidden from the transmitter any time during the transmission of the data frame. This leads to a) increased probability of collisions, and b) the transmission time wasted as a result of each collision. The RTS/CTS method uses a handshake protocol to reduce the negative impact of hidden terminals. However, this increase in the probability of successful delivery is achieved at the expense of increased overhead involved with the exchange of RTS and CTS frames, which can be significant for short data frames. A successful exchange of RTS and CTS frames attempts to reserve the channel for the time duration needed to transfer the data frame under consideration. The present approach uses an RTS/CTS method of Carrier Sense Multiple Access (CSMA), which can be best described as CSMA with Collision Avoidance (CA), i.e., CSMA/CA. It should be noted that the basic access method is also implicitly captured in the present analytic model because of the backoff rules described hereafter.

In the RTC/CTS protocol, a node senses the state of a channel before initiating a transmission to determine if another node is transmitting. The node proceeds with its transmission if the medium is determined to be idle for an interval that exceeds the Distributed InterFrame Space (DIFS). If the medium is busy, then the backoff rules apply, which are as follows: the node defers until after a DIFS is detected, and then generates a random backoff period for an additional deferral time before transmitting. This minimizes collisions during contention between multiple nodes. The backoff period is used to initialize a backoff timer. The backoff timer is decremented only when the medium is idle; it is frozen when the medium is busy. After a busy period, the decrementing of the backoff timer resumes only after the medium has been free longer than a DIFS. The Contention Window (CW) is a node state variable and it initially takes a value CWmin. The backoff period is chosen as (random(0, 1)CW*SLOT), where SLOT is the time slot size. Thus, on an average it is expected to be CW*SLOT/2. A node initiates a transmission when the backoff timer reaches zero.

Once the transmitter initiates a transmission, it sends an RTS frame after the channel has been idle for a time interval exceeding DIFS. On receiving an RTS frame the receiver responds with a CTS frame (the CTS frame acknowledges the successful reception of an RTS frame), which can be transmitted after the channel has been idle for a time interval exceeding a Short Inter Frame Space (SIFS) whose value is less than DIFS. After the successful exchange of RTS and CTS frames, the data frame (DATA) can be sent by the transmitter after waiting for an additional time interval SIFS. The destination will confirm the success of data transmission with a positive Acknowledgment (ACK) message back to the source. At the transmitter, if either a CTS frame is not received within a predetermined time interval (CTSTimeout) or if an ACK message is not received within a predetermined time interval (ACKTimeout), then three things happen: (i) the source node will double its maximum contention window; (ii) the source nodes will perform the backoff rules alone; and (iii) the source nodes will initiate the next RTS attempt, i.e., the RTS is retransmitted. After a maximum retry (MaxRetry) of attempts to transmit RTS and DATA has been reached, the packet is discarded. The contention window CW takes value in the range [CWₘᵢₙ, CWₘᵢₙ2^{(MaxRetry-1)}].

The SLOT, CWₘᵢₙ, SIFS, DIFS, and the length of various control frames (RTS, CTS, and ACK) are all model constants and are based on clear channel assessment time, Receive (Rx)-Transmit (Tx) turnaround time, and air propagation time. The size of DATA depends on the traffic that is being transmitted. The MaxRetry, CTSTimeout and ACKTimeout are model variables that can be tuned or adapted. Additionally, IEEE 802.11b allows for one of four possible data rates DR: 1, 2, 5.5 and 11 Mbit/s by using different codes length/type (11/Barker sequence, 11/Barker sequence, 8/CCK, 8/CCK) and modulations (DBPSK, DQPSK, DQPSK, DQPSK) appropriately. The DR is a tunable model variable that can be set to one of the four values. Setting the DR would correspond to some device/radio setting transmit power in dBm, temperature in Kelvin, noise factor, minimum receive power threshold (in dBm), and bit error rate of the channel. For each DR setting there is a corresponding radio transmission range Rt and radio sensing range Rs such that Rt<Rs. Any receiver node at a distance ≦Rt from the transmitter can hear and decode the frame fully at DR data rate and if it is at a distance >Rt but ≦Rs, it can hear and sense the transmitter, but cannot decode the frame. If a receiver is at a distance greater than Rs then it cannot even hear or sense the transmitter. The model constants with their values and model variables with their default values are listed in Table 1.

TABLE 1
IEEE 802.11b MAC Model Parameters

| | | | Model Variable | |
|---|---|---|---|---|
| Model Constant | Static Values | | (Adaptable) | Default Values |
| SLOT | 20 | μs | MaxRetry | 6 |
| CWₘᵢₙ | 32 | | CTSTimeout | 308 μs |
| SIFS | 10 | μs | ACKTimeout | 308 μs |
| DIFS | 50 | μs | DR | 2 Mbps - also tied |
| | | | | with Rt and Rs |
| RTS | 44 | bytes | | |
| CTS | 38 | bytes | | |
| ACK | 38 | bytes | | |

It should be noted that RTS and CTS frames contain a duration field that indicates the period the channel is to be reserved for transmission of the actual data frame. This information is used by nodes that can hear either the transmitter and/or the receiver to update their Net Allocation Vectors (NAV), a timer that is always decreasing if its value is non-zero. A node is not allowed to initiate a transmission if its NAV is non-zero. The use of NAV to determine the busy/idle status of the channel is referred to as the virtual carrier sense mechanism. Since nodes that can hear either the transmitter or the receiver resist from transmitting during the transmission of the data frame under consideration, the probability of its success is increased.

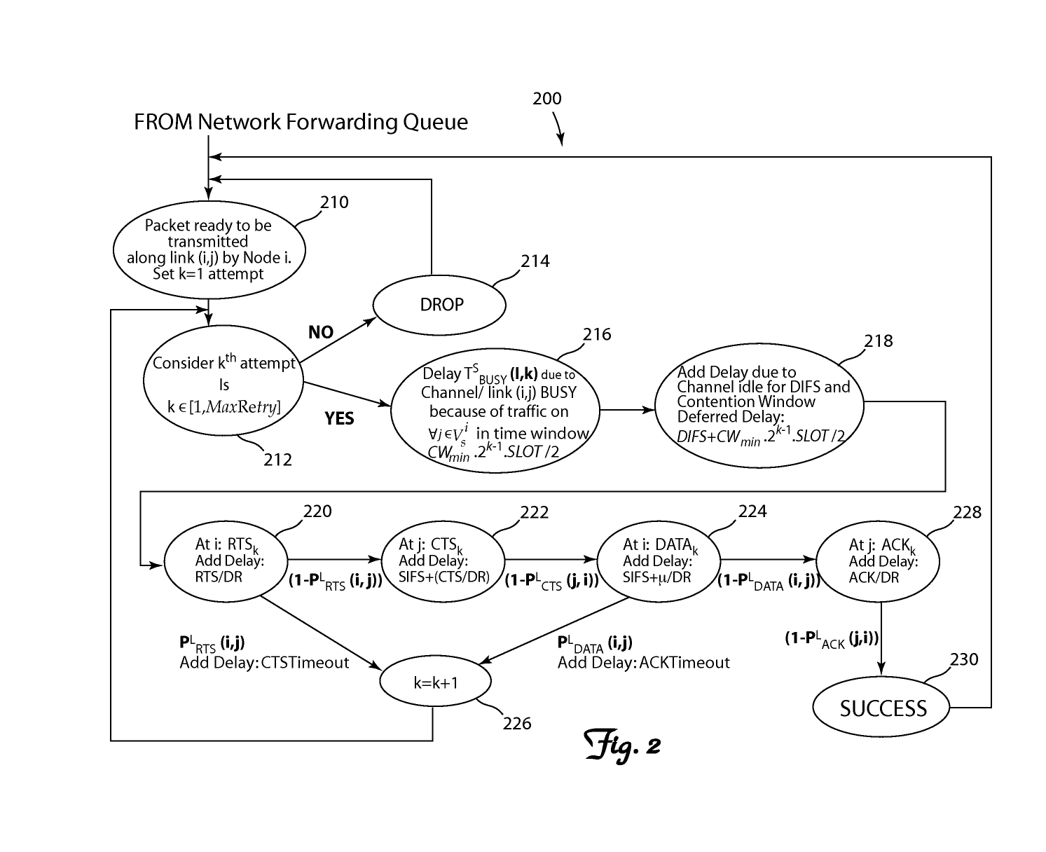

The model variables for every node i in graph G(V, E) can be represented by (MaxRetryⁱ, CTSTimeoutⁱ, ACKTimeoutⁱ, DRⁱ) and the associated ranges by (Rₜⁱ, Rₛⁱ). Three sets are defined for node i:
1) Vₜⁱ={j ∈ V|distance (i, j)≦Rₜⁱ}. This means that: a) i can send packets to any node in Vₜⁱ at data rate DRⁱ, and b) if i ∈ Vₜ^{j}, then it can receive packets from j at data rate DR^{j}.
2) Vₛⁱ={j ∈ V|distance (i, j)≦Rₛ^{j}}. This set denotes: a) the nodes j whose transmissions are physically sensed by i and thereby determine if the channel is busy or idle due to transmissions from nodes such as j, and b) in particular, if additionally distance (i,j)≦Rₜ^{j}, then i can decode the RTS and CTS control frame transmitted from j, even if the frames are not destined to it. This is the virtual carrier sensing mechanism mentioned in the previous paragraph. When i sees any traffic transmitted by any node in Vₛⁱ it stops transmitting any frame and freezes its contention window CW and the backoff timer (because the backoff timer is not decremented when the medium is busy) thereby prolonging a backoff. This is indicated in the variable T^{S}_{Busy}(i, k) (in FIG. 2 discussed hereafter). Note that the traffic transmitting from i and the traffic transmitted from any node in Vₛⁱ are mutually exclusive (non-overlapping). Also note that there is no symmetric property here, i.e., if j ∈ Vₛⁱ, then i may or may not be part of Vₛ^{j} reflecting the scenario that transmissions from j are sensed by i, but not the reverse. This scenario happens because of different power transmission settings at node i and node j, and this can also happen in adaptation of parameters.
3) Hₛⁱ={(j, k)|distance (i, j)≦Rₜⁱ and distance (k, j)≦Rₜ^{k} and (distance (i, k)>Rₛⁱ or distance (i, k)>Rₛ^{k})}. All this means if (j, k) ∈ Hₛⁱ, then overlapping traffic intervals on directed links (i, j) (k, j) ∈ E may collide and the packet can be lost, i.e., if there is traffic from i→j and k→j, then the traffic may collide at j. This is the set of hidden terminals that affect the transmissions at station i. The traffic originating from such hidden terminals can cause packet collisions and loss of RTS, CTS, DATA, and ACK packets.
   The sets Vₜⁱ, Vₛⁱ and Hₛⁱ can be precomputed for all i ∈ V. The reason is that the topology does 5 not change for the analysis.

A finite state machine (FSM) 200 summarizing the previous protocol from the transmitter perspective is shown in FIG. 2. The FSM 200 is for a packet transmitted from node i to node/in an 802.11b network. From the network forwarding queue, at state 210 a packet is ready to be transmitted along link (i, j) by node i, and a k=1 attempt is set. At state 212 a determination is made whether k ∈ [1, MaxRetry]. If no, then the attempt is dropped at 214, and FSM 200 is returned to state 210; if yes, then a delay T_{Busy}^{S}(i, k) is accepted in state 216 due to a channel/link (i, j) BUSY because of traffic on ∀j ∈ Vₛⁱ in time window CWₘᵢₙ.2^{k-1}.SLOT/2. An add delay is accepted at state 218 due to channel idle for DIFS and a contention window deferred delay: DIFS+CWₘᵢₙ.2^{k-1}.SLOT/2.

In a state 220, node i has an RTSₖ add delay: RTS/DR. In a state 222, node j has a CTSₖ add delay: SIFS+(CTS/DR). The term (1−P_{RTS}^{L}(i, j)) is transmitted to node j in state 222 from node i in state 220. In a state 224, node i has a DATAₖ add delay: SIFS+μ/DR. The term (1−P_{CTS}^{L}(j, i)) is transmitted to node i in state 224 from node j in state 222. If the term P_{RTS}^{L}(i, j) is transmitted from node i in state 220, then an add delay CTSTimeout is generated in state 226 where k=k+1 attempts are incremented, and FSM 200 is returned to state 212. If the term P_{DATA}^{L}(i, j) is transmitted from node i in state 224, then an add delay ACKTimeout is generated in state 226 where k=k+1 attempts are incremented, and FSM 200 is returned to state 212. In a state 228, node j has a ACKₖ add delay: ACK/DR. The term (1−P_{DATA}^{L}(i, j)) is transmitted to node j in state 228 from node i in state 224. Once the term (1−P_{ACK}(j, i)) has been transmitted by node j in state 228, then the data packet has been successfully transmitted (230) along link (i, j), and FSM 200 is returned to state 210. The goal of the analysis then is to be able to first infer and/or compute the terms: T_{Busy}^{S}(i, k), P_{RTS}^{L}(i, j), P_{CTS}^{L}(j, i), P_{RTS}^{L}(i, j), P_{DATA}^{L}(i, j), and P_{ACK}^{L}(j, i).

B. Network Layer Forwarding Protocol

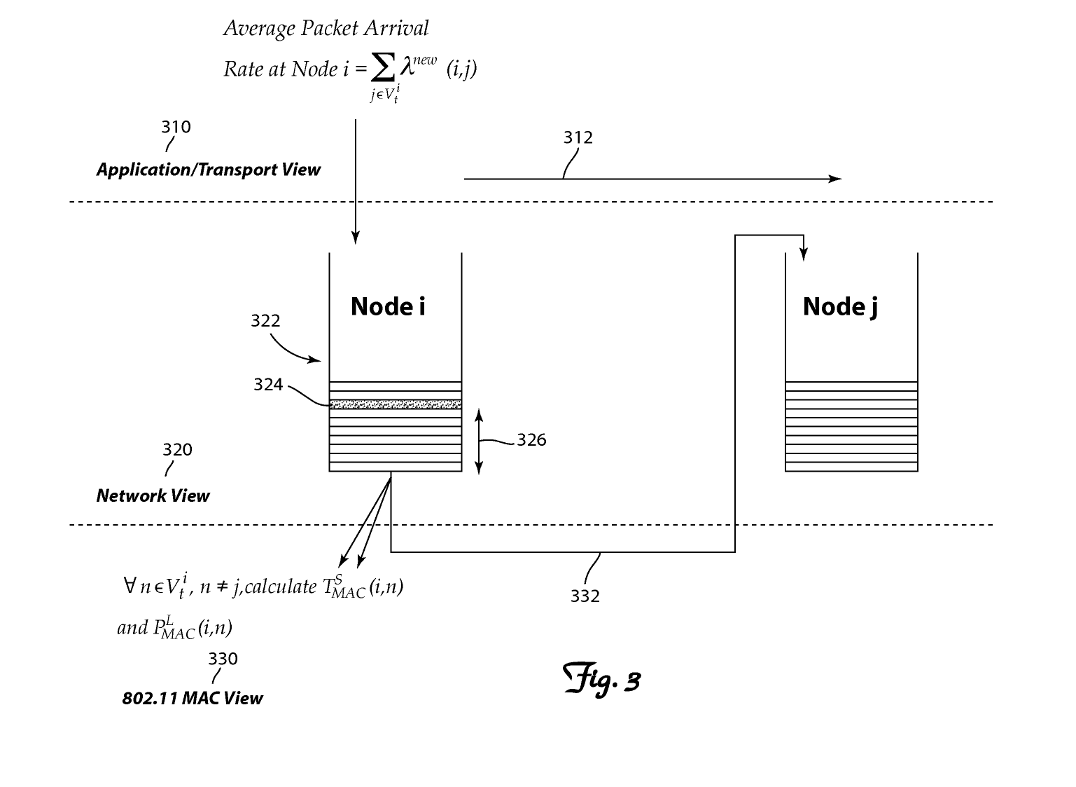

The network layer forwarding protocol is shown in FIG. 3, which is a schematic diagram of network queue behavior for transmission of a packet from node i to node j. The average rate of packet traffic arriving into the network queue at node i is given by Σj∈ vₜⁱλ^{new}(i, j), which is set forth in application/transport view 310 of FIG. 3. It should be noted that the transport or application traffic arrives at the queue in an independent manner. In addition, the average transport packet service time T^{S}(i, j) and average transport probability of packet loss P^{L}(i,j) need to be determined at 312 in application/transport view 310.

In network view 320, a network forwarding/holding queue 322 for node i is modeled as an infinite queue (i.e., no packet drops in the queue as a result of buffer overflow), with a single server and first-come-first-served (FCFS) scheduling discipline, where: (i) the arrival traffic is independent, but whose distribution is unknown, but its average rate is known, and (ii) departure traffic is not independent of each other. This is referred to in the Kendall notation as G/G/1/∞/FCFS queue. As shown in network view 320, a packet of interest 324 is in queue 322 of node i. The average wait time in node i is indicated at 326 and is denoted as T^{WAIT}(i).

In the 802.11 Mac view 330, the average MAC packet service time T_{MAC}^{S} (i, j) and the average MAC probability of packet loss P_{MAC}^{L}(i, j) need to be determined at 332. The average transport packet service time T^{S}(i, j) and the average transport packet loss ratio P^{L}(i, j) are computed as T^{S}(i, j)=T_{MAC}^{S}(i, j)+T^{WAIT}(i), and P^{L}(i, j)=P_{MAC}^{L}(i, j). This is because no loss happens in the network queue/buffer and the time spent waiting in the queue at node i needs to be added, which is denoted T^{WAIT}(i). As set forth in the 802.11 Mac view 330, if ∀n ∈ Vₜⁱ, n≠j, then T_{MAC}^{S}(i, n) and P_{MAC}^{L}(i, n) are calculated.

Reiterating, the goal of the analysis is to then compute the terms: T^{WAIT}(i), T_{MAC}^{S}(i, j) and P_{MAC}^{L}(i, j) and relate it to the IEEE 802.11 MAC terms: T_{Busy}^{S}(i, k), P_{RTS}^{L}(i, j), P_{CTS}^{L}(j, i), P_{RTS}^{L}(i, j), P_{DATA}^{L}(i, j), and P_{ACK}^{L}(j, i).

### Analysis Framework Model

As discussed previously, the following 2 equations hold:

T^{S}(i, j)=T_{MAC}^{S}(i, j)+T^{WAIT}(i) (2)

P^{L}(i, j)=P_{MAC}^{L}(i, j) (3)

The k^{th} attempt of a packet at node i to node j by the MAC layer where k ∈ [1,MaxRetry] will be considered initially. At the k^{th} attempt, the average probability of frame/packet loss is denoted by P_{MAC}^{L}(i, j, k), the average service time of the successful packet is T_{MAC}^{L}(i, j, k), and the average wasted time before node i figures that the current attempt has failed is T_{MAC}^{L}(i, j, k). Looking at FIGS. 2 and 3, it is clear that:

$$\begin{matrix} {P}_{MAC}^{L} ( i , j ) = {\prod }_{k = 1}^{Max Retry} {P}_{MAC}^{L} ( i , j , k ) & ( 4 ) \\ {T}_{MAC}^{S} ( i , j ) = {{\sum }_{k = 1}^{Max Retry}}_{{k}^{th} attempt is \\ successful and all \\ 1 to ( k - 1 ) \\ unsuccessful} [ ( 1 - {P}_{MAC}^{L} ( i , j , k ) \cdot {T}_{MAC}^{S} ( i , j , k ) ] + [ ( {\prod }_{l = 1}^{k - 1} {P}_{MAC}^{L} ( i , j , l ) ) \cdot ( {\sum }_{l = 1}^{k - 1} {T}_{MAC}^{L} ( i , j , l ) ) ] & ( 5 )\end{matrix}$$

Now to compute P_{MAC}^{L}(i, j, k), T_{MAC}^{L}(i, j, k), and T_{MAC}^{S}(i, j, k). Looking at FIG. 2 again it is clear that:

$$\begin{matrix}{P}_{MAC}^{L} ( i , j , k ) = {P}_{RTS}^{L} ( i , j ) + [ ( 1 - {P}_{RTS}^{L} ( i , j ) ) \cdot ( 1 - {P}_{CTS}^{L} ( j , i ) ) \cdot {P}_{DATA}^{L} ( i , j ) ] & ( 6 ) \\ {T}_{MAC}^{L} ( i , j , k ) = {T}_{busy}^{S} ( i , k ) + ( DIFS + {CW}_{min} \cdot SLOT \cdot {2}^{k - 2} ) + \frac{RTS}{DR} + ( {P}_{RTS}^{L} ( i , j ) \cdot CTSTimeout ) + [ ( 1 - {P}_{RTS}^{L} ( i , j ) ) \cdot ( 1 - {P}_{CTS}^{L} ( i , j ) ) \cdot {P}_{DATA}^{L} ( i , j ) \cdot ( 2 \cdot SIFS + \frac{CTS + μ}{DR} + ACKTimeout ) ] & ( 7 ) \\ {T}_{MAC}^{S} ( i , j , k ) = {T}_{Busy}^{S} ( i , k ) + DIFS + {CW}_{min} \cdot SLOT \cdot {2}^{k - 2} + \frac{RTS + CTS + μ + ACK}{DR} + 2 \cdot SIFS & ( 8 )\end{matrix}$$

Next, the following five terms need to be calculated: T_{Busy}^{S}(i, k), P_{RTS}^{L}(i, j), P_{CTS}^{L}(j, i), P_{DATA}^{L}(i, j), and T^{WAIT}(i). Notice that P_{ACK}^{L}(j, i) is not needed in the calculations/computation. Abusing notation further, let

$${λ}^{new} ( i ) = {\sum }_{j ∈ {v}_{t}^{i}} {λ}^{new} ( i , j )$$

denote the total arrival rate of packets in node i which will be transmitted over the channel.

First, other results are needed. Consider placing m balls in N bins, where m is small and N is very large. Assuming the balls can be placed equally likely in any bin, F(m,N) is computed, which is the expected (average) fraction of N bins occupied.

$$\begin{matrix}F ( m , N ) = {\sum }_{k = 1}^{m} Pr \{ \begin{matrix}exactly k bins are \\ occupied and n - k unoccupied\end{matrix} \} \cdot \frac{k}{N} \\ = {\sum }_{k = 1}^{m} \frac{( \begin{matrix}m \\ k\end{matrix} ) ( \begin{matrix}N \\ k\end{matrix} ) k ! {k}^{m - k}}{{N}^{m}} \cdot \frac{k}{N} \\ = {\sum }_{k = 1}^{m} ( \begin{matrix}m \\ k\end{matrix} ) \cdot {k}^{m - k + 1} \cdot \frac{N !}{( N - k ) ! {N}^{m + 1}} \\ = {N}^{N - m - \frac{1}{2}} \cdot {\sum }_{k = 1}^{m} ( \begin{matrix}m \\ k\end{matrix} ) \cdot {k}^{m - k + 1} \cdot \frac{1}{{{e}^{k} ( N - k )}^{N - k + \frac{1}{2}}}\end{matrix} \qquad ( 9 )$$

As it is undesirable to compute N! for large N, the last line uses the Stirling's Approximation for

$$N ! \approx \sqrt{2 π N} {( \frac{N}{e} )}^{N} .$$

Using equation 9, calculate the fraction of time in finite horizon window size of 1 second which are busy with traffic in V_{S}ⁱ as F(m,N) and use this normalized fraction to set T_{Busy}^{S}(i, k) scaled appropriately for a congestion window in the k^{th} attempt.

$${T}_{Busy}^{S} ( i , k ) \approx {CW}_{min} \cdot SLOT \cdot {2}^{k - 2} \cdot F ( m , N ) \\ where m = floor ( \frac{( RTS + CTS + μ + ACK ) \cdot ( {\sum }_{j ∈ {v}_{s}^{i}} {λ}^{new} ( j ) )}{min \{ RTS , CTS , μ , ACK \}} ) \\ and N = floor ( \frac{DR}{min \{ RTS , CTS , μ , ACK \}} ) \qquad ( 10 )$$

Now to calculate P_{RTS}^{L}(i, j). Assuming the RTS is transmitted uniformly within the horizon window of 1 second, the probability of not colliding with the RTS between (i, j) is (1−RTS/DR). If the total number of packets that are generated by the hidden terminals is given by m, then for all these packets to not collide with the given RTS, the probability is (1−RTS/DR)^{m}. Hence, the following:

$$\begin{matrix} {P}_{RTS}^{L} ( i , j ) = 1 - {( 1 - RTS / DR )}^{m} & ( 11 ) \\ {P}_{DATA}^{L} ( i , j ) = 1 - {( 1 - μ / DR )}^{m} & ( 12 ) \\ {P}_{CTS}^{L} ( j , i ) = 1 - {( 1 - RTS / DR )}_{1}^{m} \\ where m = floor ( \frac{( RTS + CTS + μ + ACK ) \cdot ( {\sum }_{( j , k ) ∈ {H}_{s}^{i}} {λ}^{new} ( k ) )}{min \{ RTS , CTS , μ , ACK \}} ) \\ where {m}_{1} = floor ( \frac{( RTS + CTS + μ + ACK ) \cdot ( {\sum }_{( j , k ) ∈ {H}_{s}^{i}} {λ}^{new} ( k ) )}{min \{ RTS , CTS , μ , ACK \}} & ( 13 )\end{matrix}$$

Finally, the queuing delay T^{WAIT}(i) is computed. The queuing delay for G/G/1 can be obtained by using a conventional transform technique that uses an iterative technique of Lindley's Integral equation and convolutions of individual probability density functions. This scheme has the advantage that it will yield the waiting time distribution with the queue in nonequilibrium conditions, or even with interarrival time and service time distributions changing from customer to customer. But the convolutions make it very compute intensive.

Instead, an upper bound for an average waiting time in a G/G/1 queue is used, which is provided for heavy traffic approximation. This is similar to the Pollaczek-Khinchin (P-K) mean value approximation for the average waiting time in a M/G/1 queue (Poisson Arrival). Waiting time is computed based on only the first order and second order moments of service time and arrival rates of the queue. Since the service distribution has been modeled independent of time specific information, the following is calculated:

$$Mean Arrival Rate \text{:} {λ}^{ne \overline{w}} ( i ) = {λ}^{new} ( i )$$

$$Variance of Arrival Times which is provided as input \text{:} {σ}_{a}^{2} ( i )$$

$$Mean Service T ime \text{:} {T}_{MAC}^{S -} ( i ) = \frac{1}{\vert {V}_{t}^{i} \vert} \cdot \begin{matrix}\sum \\ j ∈ {V}_{t}^{i}\end{matrix} {T}_{MAC}^{S} ( i , j )$$

$$Variance of Service T ime \text{:} {σ}_{S}^{2} ( i ) = ( \frac{1}{\vert {V}_{t}^{i} \vert} \cdot \begin{matrix}\sum \\ j ∈ {V}_{t}^{i}\end{matrix} {( {T}_{MAC}^{S} ( i , j ) )}^{2} ) - {( {T}_{MAC}^{S -} ( i ) )}^{2}$$

$$ρ ( i ) = {λ}^{ne \overline{w}} ( i ) \cdot {T}_{MAC}^{S -} ( i )$$

$${T}^{WAIT} ( i ) \leq \frac{ {λ}^{ne \overline{w}} ( i )}{2 ( 1 - ρ ( i ) )} \cdot ( {σ}_{a}^{2} ( i ) + {σ}_{s}^{2} ( i ) )$$

### Adaptation Framework

The present invention is useful in static sensor networks since the physical environment and position of nodes seldom change, and thus the analysis framework can be applied without much loss of accuracy. An objective of the adaptation framework is to choose a best set of parameters under given inputs such as traffic rate, number of nodes, queue size, etc. It is intuitively expected that the best parameters will be dynamic depending on those input values. The adaptation framework includes a new or leaving traffic flow or other input variables' change trigger adaptation engine so that a new optimal parameter set will be selected.

In many cases, applications in sensor networks tend to have periodic and relatively long lasting traffic flows. In a static sensor network, in most cases the trigger for adaptation would be a new or leaving traffic flow trigger. Due to the limited energy and computation resources of sensor nodes, it is very challenging to run a distributed adaptive scheme in a sensor network. Not to mention that a distributed adaptive scheme itself is very challenging regardless of computation power requirements due to interdependency of nodes and potentially huge overhead of state exchanges. Thus, the present invention provides a centralized adaptation technique where a sink node will determine and propagate (if there is a change) best parameters for sensor nodes in the network. Each sensor node will adapt its parameters accordingly. Depending on computation power and expected adaptation delay, the sink node can select homogeneous parameters for all the nodes or heterogeneous values for each node which can further optimize the network performance.

The problem to find optimal parameters that maximize network performance is a combinatorial optimization problem, which is a NP-hard (Nondeterministic Polynomial-time hard) problem. It has led to a wide range of heuristic algorithms that perform various kinds of searches in the solution space. These heuristics can be classified as instance-based or model-based approaches. The instance-based approach includes most classic search algorithms such as genetic algorithms and gradient-based search algorithms. An exemplary genetic algorithm is described in J. Holland, Adaptation in Natural and Artificial Systems, University of Michigan Press (1975). An exemplary gradient-based search algorithm is described in K. Ariyur & M. Krstic, Real-time Optimization by Extremum-seeking Control, Wiley/Mathematics & Statistics/Optimization (2003) (hereafter “Ariyur et al.”). The gradient-based search algorithms generate new solution sets using current solutions or current populations of solutions only.

The model-based algorithms generate new solutions with a probabilistic model based on current solutions so that searches will concentrate in the regions containing high quality solutions. The model-based approach is more efficient to reach to an optimal point than instance-based solutions if parameters are independent, which is not always guaranteed in network optimization problems. Thus, the present invention utilizes instance-based search algorithms such as a genetic algorithm and a gradient-based search technique (e.g., extremum seeking) These approaches provide unique advantages and simplicity compared to other mechanisms (e.g., simulated annealing).

The genetic algorithm encodes a potential solution of a specific problem on a simple chromosome-like data structure. It starts with initial population, i.e., chromosomes, evaluates them and applies recombination operators such as mutation and cross-over to produce next generations until it reaches to the last generation (determined by termination function). The genetic algorithm is very flexible and works for most combinatorial optimization problems. It does not pose any constraint on parameters/variables which is very important in network optimization. However, the genetic algorithm is very slow in convergence, and definition of a termination function can be challenging.

A gradient-based search algorithm such as the extremum seeking (ES) algorithm, on the other hand, provides a search mechanism that converges fast as it terminates once it reaches to a local optimum. It is known to work well for a system with an extremum (e.g., minimum). It is possible, however, that this search mechanism can be stuck in a local optima and thus cannot reach the global optimal value. To address the potential drawbacks of each approach, the present invention uses a hybrid of the two approaches, with the genetic algorithm used at system startup or periodically, and the extremum seeking algorithm used for real-time adaptation to accommodate changes. The genetic algorithm can be used occasionally (periodically) to find a best parameter set. For example, if an application can tolerate the large delay, the genetic algorithm can be used infrequently to resync to the best parameter configuration. Since the performance of extremum seeking is tightly coupled with the quality of initial conditions, a good starting point for extremum seeking is identified using the genetic algorithm search.

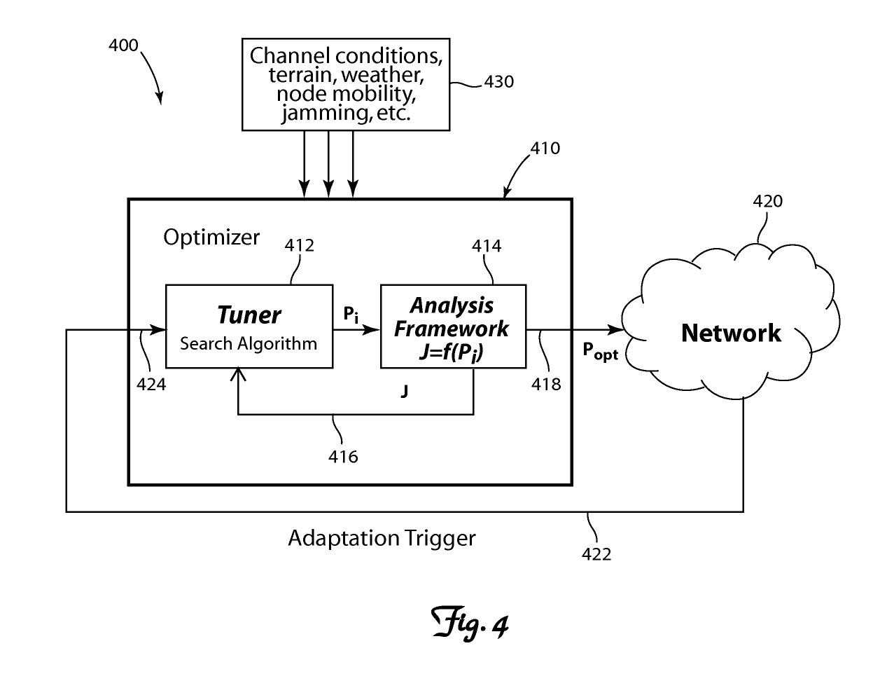

FIG. 4 is a schematic diagram of an adaptation framework system 400 for network optimization according to one embodiment of the present invention. The system 400 includes an optimizer module 410 having a tuner module 412, and an analysis framework module 414 in operative communication with tuner module 412. The tuner module 412 contains search algorithms such as the genetic algorithm and extremum seeking as described above. The analysis framework module 414 contains software for running the analysis framework discussed previously. A feedback loop 416 is run from analysis framework module 414 to tuner module 412. An output 418 from analysis framework module 414 communicates with a wireless network 420. An adaptation trigger 422 operatively connects network 420 with an input 424 to tuner module 412. The trigger 422 can be activated based on new network traffic flow, joining or leaving traffic flow, environmental changes, etc. so that a new optimal parameter set will be selected when needed. A variety of predetermined conditions 430, such as channel load, terrain, weather, node mobility, jamming, etc. can be used to initiate optimizer module 410.

During operation of adaptation framework system 400, the genetic algorithm in tuner module 412 is used initially to identify a good starting point for extremum seeking, which is used for real-time adaptation to accommodate changes. The tuner module 412 feeds an initial parameter (Pᵢ) into analysis framework module 414 to find a local optimum parameter (Pₒₚₜ). If no local optimum parameter is found, then feedback loop 416 sends a signal J, corresponding to the available bandwidth, to tuner module 412 for further searching. Once a local optimum parameter is found, then analysis framework module 414 transmits Pₒₚₜ to network 420 through output 418. When adaptation trigger 422 is activated, a start signal is sent to tuner module 412 through input 424. The tuner module 412 can be invoked whenever a new network traffic session has been introduced or when a network traffic session ends. A time slot size for packets in wireless network 420 is adaptively adjusted with the search algorithms to maximize network throughput and minimize network latency.

A discussion and analysis on the dependency and relationship among parameters (e.g., SLOT, CTSTimeout) is set forth as follows.

### Analysis for Adaptation

The parameters of a wireless network can potentially be adapted to different conditions of traffic, environment, and topology/mobility to preserve or improve various performance objectives. These are primarily the maximization of capacity and the minimization of packet loss, and combinations thereof. The following discussion is restricted to adapting to traffic changes. First, the problem of minimizing packet loss for a prescribed traffic condition is considered. Second, the problem of minimizing service time while keeping losses small on a path in the network is considered.

The following observations are relevant to any scheme for adapting the parameters of 802.11 networks and many other wireless networks. Traffic affects the service time characterization solely through the ratio m in busy time T_{BUSY}^{S}, and through the ratios m and m₁ in Eqns. (11), (12), and (13). These ratios again depend upon the average service times of the transmitting, receiving, and hidden terminals.

Within any network, the only nodes that affect the performance of a given node are those that interfere with its reception and those that interfere with the reception of the packets it sends to its one hop neighbors. This implies that feedback need not be applied across the network in more than two hops. Moreover, the only information that is needed in any feedback is the degree of interference that a node is causing other nodes, captured in the exponents mᵢ. This motivates two distinct kinds of feedback schemes for performance optimization of a wireless network—those that do not use any communication overhead and simply use conservative estimates of interference to adjust their own parameters, and those that transmit feedback across a couple of hops.

Of the parameters that can be controlled, minimum contention window size CWₘᵢₙ, and number of retries k and the SLOT time always appear together. Since SLOT is an unconstrained real variable, it is the best variable to adapt from the three.

The other variables that can potentially be adapted are the timeouts −CTSTimeout and ACKTimeout, and both of these can be expressed as affine parameterizations of SLOT:

$$\begin{matrix}CTSTimeout = \frac{RTS + CS}{DR} + SLOT + DIFS + SIFS & ( 14 ) \\ ACKTimeout = \frac{μ + ACK}{DR} + SLOT + DIFS + SIFS + α , & ( 15 )\end{matrix}$$

where α is the adaptive adjustment to ACKTimeout, and the minimum SLOT itself is a function of DR−

SLOT=1/DR+θ, (16)

where θ is the adaptive adjustment to SLOT.

If DR is held and therefore the topology is fixed, the only variables that can be adjusted are θ and α, which can immediately handle changes in packet size, and adjust to changes in traffic or in accuracy requirements.

A. Measurements for Adaptation

The main measures of performance of a wireless network are packet loss and service time/capacity, whether on a link, or on a path, or as an end-to-end measure. Packet loss depends solely upon the extent of interference and occupancy of the channels that determine probabilities of collisions. Traffic enters into the calculation of packet loss through the exponents mᵢ as pointed out above, and enters into service time through packet loss and busy time. The exponents can be calculated from estimates of the loss probabilities which are derived below.

The loss probabilities can be estimated through using simple first order infinite impulse response (IIR) filters with suitable exponents γ_{RTS},γ_{CTS},γ_{DATA}:

\hat{P}_{RTS}^{L}(k+1)=(γ_{RTS})\hat{P}_{RTS}^{L}(k)+(1−γ_{RTS})μ_{RTS} (17)

\hat{P}_{CTS}^{L}(k+1)=(γ_{CTS})\hat{P}_{CTS}^{L}(k)+(1−γ_{CTS})μ_{CTS} (18)

\hat{P}_{DATA}^{L}(k+1)=(γ_{DATA})\hat{P}_{DATA}^{L}(k)+(1−γ_{DATA})μ_{DATA} (19)

where the inputs to the filters are obtained from the instantaneous relative frequencies of lost packets.

$$\begin{matrix}{u}_{RTS} = \frac{{N}_{RTS}^{lost}}{{N}_{RTS}} & ( 20 ) \\ {u}_{CTS} = \frac{{N}_{CTS}^{lost}}{{N}_{CTS}} & ( 21 ) \\ {u}_{DATA} = \frac{{N}_{DATA}^{lost}}{{N}_{DATA}} , & ( 22 )\end{matrix}$$

where N_{RTS}, N_{CTS}, N_{DATA} are the total number of RTS, CTS, DATA sent over the time interval and N_{RTS}^{L}, N_{CTS}^{L}, N_{DATA}^{L} are the packets lost in that same time interval, and the averages are taken over a time window where the traffic does not change appreciably. Alternatively, an average of lost packets can be obtained per time window to estimate loss probabilities. Finally, the overall loss probability can also be calculated for use as an adaptation objective. The other measurement needed is that of the average service time, or equivalently, the latency. This can also be estimated directly using an IIR filter:

\hat{T}_{s,i}(k+1)=γ_{TS} \hat{T}_{S,i}(k)+(1−γ_{TS})T_{MAC}^{S}(i, j) (23)

T_{MAC}^{S}(i, j)=time(packet exit)−time(packet entry), (24)

where the time stamps for packet entry into the node's buffer and its exit from the MAC buffer are stored for the measurement.

B. Feedback and Adaptation

With the measurements above, there are several kinds of feedback and adaptation schemes that can be designed. The feedback control laws need not depend upon the model presented above, unless it is desired to use estimates of model parameters. The other point to note is that it is not necessary to propagate feedback throughout the network in a distributed adaptation technique. This is because the hidden terminals are the farthest nodes that affect performance of any given node, and they are necessarily within a 2-hop neighborhood.

There is a trade-off between distributed feedback and feedback using some amount of communication overhead. Every node contributes to the service time of other nodes in its neighborhood through its use of the channel, or through interference. For a given traffic condition, loss can be reduced through increasing service time until the service time that will still satisfy traffic requirements is maximized. Alternatively, the service time can be minimized with a constraint on the loss rate.

Various feedback and adaptation schemes that can be designed according to the present invention are described as follows.

In a proportional-integral feedback scheme, the difference between the loss set point and actual loss is kept small. Alternatively, the demanded service can be tracked subject to the constraint of loss probability. This would be a switching or hybrid controller.

In a gradient-based adaptation scheme, parameters are adapted to minimize loss probability or service time through using the estimates of those two quantities.

In an adaptation scheme with overhead, every node gets the exponents to which it contributes through interference and busy time. A node can reduce or increase its intensity of usage depending upon the average exponent. A node can also calculate its own usage of the channel, and use feedback to equalize its usage/traffic unit to those of other nodes. The notion of average usage/traffic may yield several distributed algorithms, or semi-distributed algorithms that will give a “fair” network.

In a convexity and distributability of adaptation scheme, global optima is checked using the above model and optimization in MATLAB, and it is determined whether distributed adaptive methods have any chance of getting to a global optimum. Given any two vectors within the constraint space, a determination is made whether any linear combination of those also lie within that space. Since all of the constraints individually appear to be convex, a determination is made how to deduce convexity of the overall set bounded by these constraints. If a single value is chosen for all nodes, this would be sub-optimal relative to choosing different values for different nodes. In addition, a determination is made whether optimizing for a vector of parameter values, with different sets for different nodes, results in the problem still being convex.

For distributability, a determination must be made whether there is distributed detectability and reachability of the overall network from each node. Detectability means that all unstable states are observable from each node, or that all states that can disrupt the performance of the node can be estimated from within the node. Reachability means that all unstable modes are controllable, or that all modes that can disrupt performance of the node are controllable from within the node. It is also possible to determine if there is a cluster distributability, i.e., if the observations and controls are combined within a set of nodes, and the network is partitioned suitably into neighborhoods, distributed detectability and reachability is obtained.

It is also possible to eliminate the effect of memory induced by the buffers through feedback, and obtain simpler distributions or simpler statistical calculations. In addition, the performance of the adaptation can be controlled and prevented from disrupting the network system by imposing constraints upon the adaptation.

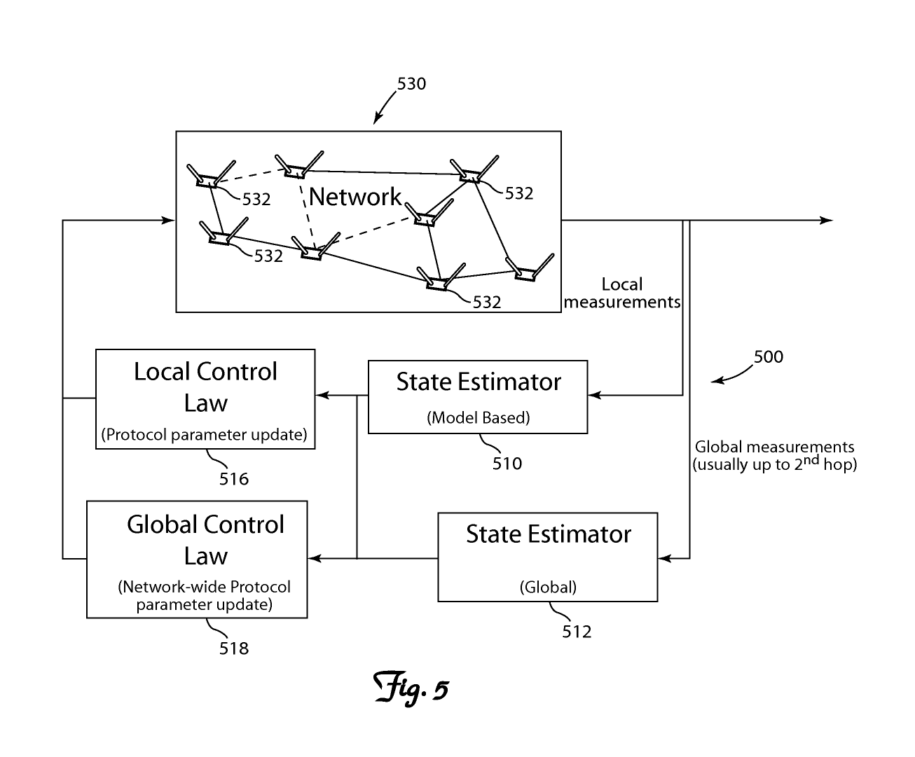

FIG. 5 is a schematic diagram of a network adaptation system 500 for wireless network optimization. The system 500 includes a first state estimator module 510, which has an analytic framework model as described previously herein. The system 500 also has a second state estimator module 512, which has an analytic framework model as described previously. The first state estimator module 510 is in operative communication with a local control law module 516, which provides local protocol parameter updates. The second state estimator module 512 is in operative communication with local control law module 516 and a global control law module 518, which provides network-wide protocol parameter updates. The local control law module 516 operatively communicates with a wireless network 530, and the global control law module 518 also operatively communicates with wireless network 530. The wireless network 530 has a plurality of wireless nodes 532 in operative communication with each other.

The first state estimator module 510 is configured to receive local measurements from a node in wireless network 530. The second state estimator module 512 is configured to receive global measurements from wireless network 530. The local control law module 516 is configured to receive input data from the first and second state estimator modules, and is configured to output local protocol parameter updates to wireless network 530. The global control law module 518 is configured to receive input data from state estimator module 512, and is configured to output network-wide protocol parameter updates to wireless network 530. The network-wide protocol parameter updates provide for capacity maximization and loss minimization in wireless network 530.

During operation of network adaptation system 500, local measurements and feedback from a single node in wireless network 530 are input into state estimator module 510. The local measurements and feedback lack communication overhead, since measurements from the node are being used to drive parameter updates on that node only. Global measurements from wireless network 530 are input into state estimator module 512. The global measurements are from other nodes, typically not more than two hops away from the single node for the purpose of a CSMA-CA network (IEEE 802.11). Estimation of node states is performed in state estimator module 512 using the analysis model that combines queuing and interference. All estimation from measurements (e.g., bit error rate, MAC losses, buffer losses/drops, throughput on a path or across a node, latency on a path or across a node) is performed through use of the network model described previously. The outputs from the state estimator modules 510 and 512 are input into local control law module 516, which in turn outputs a local protocol parameter update to the single node in wireless network 530. The output from the state estimator module 512 is also input into global control law module 518, which in turn outputs a network-wide protocol parameter update to wireless network 530.

In a method for optimizing wireless network 530, local measurement and feedback data is obtained from a node 532 in wireless network 530. A state of node 532 is estimated by using the local measurement and feedback data in the analysis framework model. The estimated state of node 532 is applied to the local control law to determine one or more local protocol parameter updates for the node, which are in turn transmitted to the node. The method can further be used to obtain global measurement and feedback data from one or more additional nodes in wireless network 530. The state of the one or more additional nodes is estimated by using the global measurement and feedback data in the analysis framework model. The estimated state of the one or more additional nodes is applied to the local control law. The estimated state of the one or more additional nodes is also applied to the global control law to determine one or more network-wide protocol parameter updates. The network-wide protocol parameter updates are then transmitted to wireless network 530.

The protocol parameter updates/control laws can have different objectives: maximizing throughput, minimizing latency, or preserving throughput and latency (usually end-to-end on a path, such as the path marked with a dotted line in wireless network 530 of FIG. 5) under a variety of conditions. The proportional-integral feedback scheme described above, for example, has set point regulation as its objective.

Instructions for carrying out the various process tasks, calculations, and generation of signals and other data used in the operation of the methods of the invention can be implemented in software, firmware, or other computer readable instructions. These instructions are typically stored on any appropriate computer readable medium used for storage of computer readable instructions or data structures. Such computer readable media can be any available media that can be accessed by a general purpose or special purpose computer or processor, or any programmable logic device.

Suitable computer readable media may comprise, for example, non-volatile memory devices including semiconductor memory devices such as EPROM, EEPROM, or flash memory devices; magnetic disks such as internal hard disks or removable disks; magneto-optical disks; CDs, DVDs, or other optical storage disks; nonvolatile ROM, RAM, and other like media; or any other media that can be used to carry or store desired program code means in the form of computer executable instructions or data structures. Any of the foregoing may be supplemented by, or incorporated in, specially-designed application-specific integrated circuits (ASICs). When information is transferred or provided over a network or another communications connection (either hardwired, wireless, or a combination of hardwired or wireless) to a computer, the computer properly views the connection as a computer readable medium. Thus, any such connection is properly termed a computer readable medium. Combinations of the above are also included within the scope of computer readable media.

The method of the invention can be implemented in computer readable instructions, such as program modules or applications, which are executed by a data processor. Generally, program modules or applications include routines, programs, objects, data components, data structures, algorithms, etc. that perform particular tasks or implement particular abstract data types. These represent examples of program code means for executing steps of the methods disclosed herein. The particular sequence of such executable instructions or associated data structures represent examples of corresponding acts for implementing the functions described in such steps.

### EXAMPLES

The following examples are given to illustrate the present invention, and are not intended to limit the scope of the invention.

### Example 1

### Analysis Validation

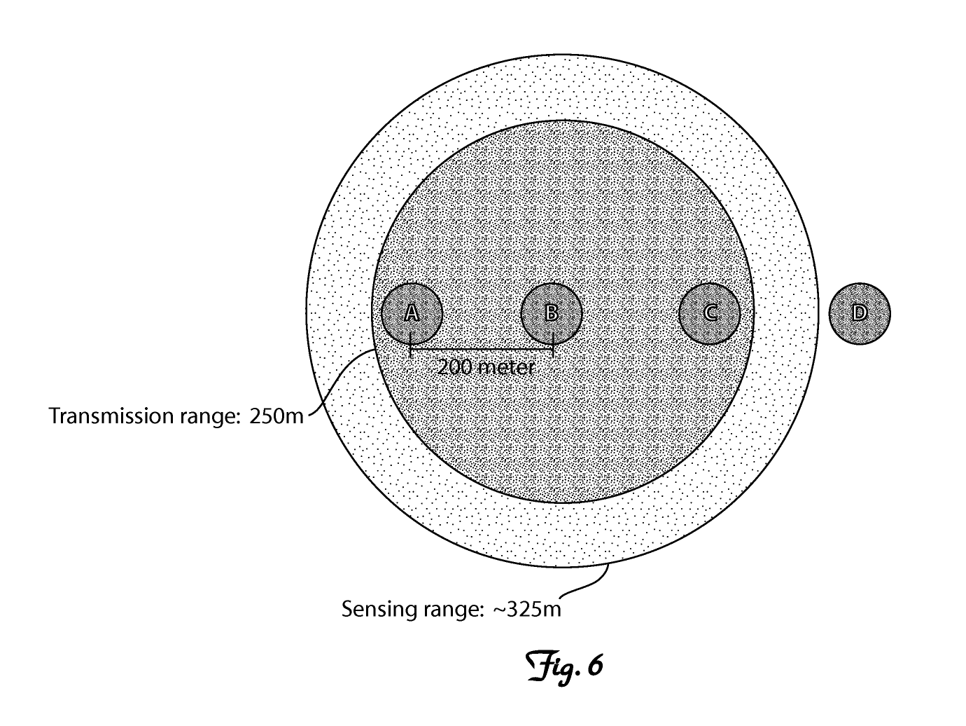

To validate the present analysis approach, the foregoing formulations were implemented in Matlab and the output values were compared to NS-2 simulation results. The NS-2 is a network simulator (available at http://www.isi.edu/nsnam/ns/) that is a discrete event simulator targeted at networking research. The NS-2 provides substantial support for simulation of TCP, routing, and multicast protocols over wired and wireless (local and satellite) networks. A simple scenario with 4 nodes (A, B, C, and D) was used as illustrated in FIG. 6. The distance between two adjacent nodes was uniformly 200 meters in a line configuration, with a transmission range of 250 m and a sensing range of about 325 m.

Table 2 summarizes the validation test results for the maximum available traffic rate from node A to node D in the presence of ongoing CBR sessions in the first column. Even though the evaluation scenario is simple, the results show consistency between analysis and NS-2 simulation results.

TABLE 2
Validation Test Results

| | Analysis Result | Simulation Result |
|---|---|---|
| | (Maximum CBR pkt rate | (Maximum CBR pkt |
| Current CBR Sessions | 1 [symbol] 4) | rate 1 [symbol] 4) |
| 2 [symbol] 3: 100 pkts/sec | 19.046 pkts/sec | 13.33 pkts/sec |
| (409600 bits/sec) | (78012.416 bits/sec) | (54599.68 bits/sec) |
| 1 [symbol] 2: 10 pkts/sec | 25.7681 pkts/sec | 28.571 pkts/sec |
| 2 [symbol] 3: 10 pkts/sec | (105546.12 bits/sec) | (117028.57 bits/sec) |
| (81920 bits/sec) | | |
| 1 [symbol] 2: 10 pkts/sec | 24.67 pkts/sec | 25 pkts/sec |
| 2 [symbol] 3: 10 pkts/sec | (101048.32 bits/sec) | (102400 bits/sec) |
| 3 [symbol] 4: 10 pkts/sec | | |
| (122800 bits/sec) | | |

### Example 2

### Adaptation Framework Validation

As follows, simulation test results for the present adaptation framework are set forth. The test results are two-fold: (1) a performance study on extremum seeking (ES); and (2) a performance study on a real-time adaptation framework based on extremum seeking Because of fast convergence and simplicity, a gradient-based search algorithm for optimization was used, in particular, the extremum seeking was used as described in Ariyur et al.

### Extremum Seeking

For the first study of ES performance, the NS-2 network simulator was used for an evaluation function. The NS-2 provides end-to-end latency and packet loss rate (primarily end-to-end latency was used for the evaluation) to the ES algorithm. In this simulation, 50 nodes were placed uniformly in a 1000×1000 m² field. The transmission range of each node with a 1 Mbps data rate was about 250 meters. The number of CBR connections was increased from 1 to 20. Each CBR session generated 10 pkts/sec with a 512 bytes constant packet size. Only a time slot size (SLOT) was varied for simplicity.

The end-to-end latency was measured by a chosen SLOT by (1) default and static setting (Default), (2) extremum seeking and (3) brute force global search (brute force search). It is notable that the brute force search was feasible since only the SLOT was changed in a step of 5 μs in a 15-50 μs range. If other parameters were introduced or the sample size increased, the brute force search would become impractical. The ES mechanism was tested only for comparison purposes.

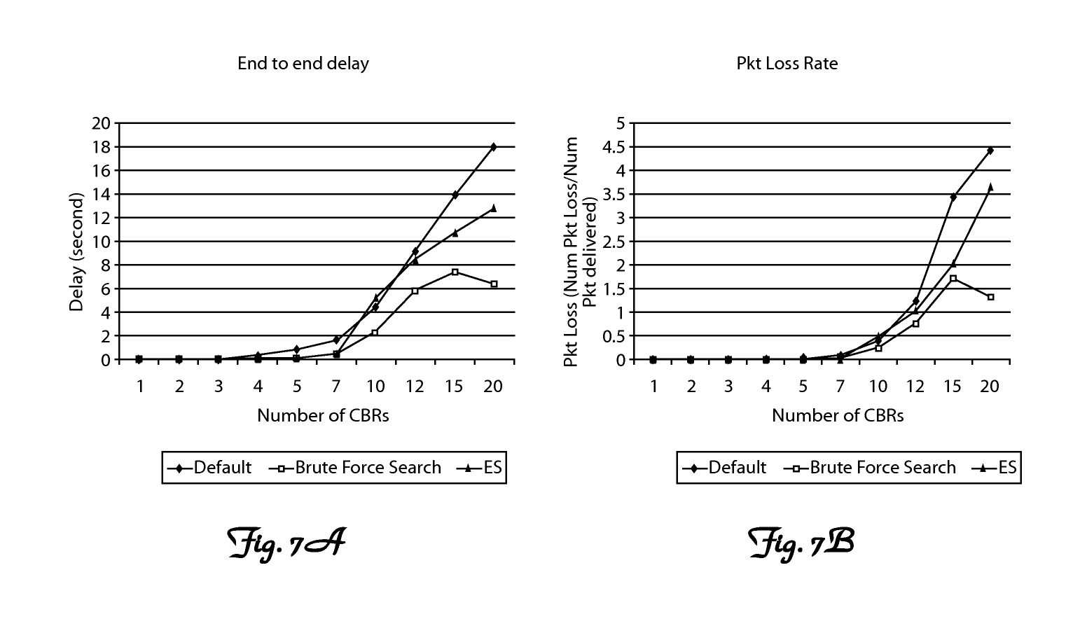

The simulation results for ES performance are shown in the graphs of FIGS. 7A and 7B. In ES, the default SLOT value was used for the initial condition. In the graphs, two important results can be observed. First, the performance difference between the brute force search and Default infers a potential and huge performance improvement by changing only the SLOT size. Second, extremum seeking chooses a parameter which achieves a better performance compared to a default static setup. Yet, due to the local search and imperfect configuration, ES may not find a global optimum.

It should be noted that a discrete ES algorithm was used, which is known to be less stable compared to a continuous ES. Thus, a continuous ES with proper configuration would be expected to result in a better performance.

### Real-Time Adaptation Framework

In the performance study of a real-time adaptation framework based on extremum seeking, an NS-2 was also used for an evaluation function. For this study, the same scenario was used as in the previous simulation with varying offered load in the network. In this evaluation, a master NS-2 process simulated a sensor network in the adaptation framework and a slave NS-2 process produced performance output of chosen parameters. At the initialization, the master NS-2 invoked a genetic algorithm with an assumption of a low offered load to configure sub-optimal initial parameters.

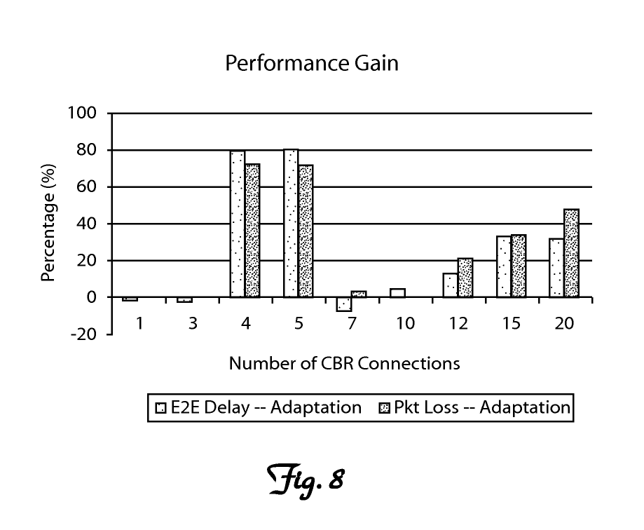

The graph of FIG. 8 shows the performance improvement by on-line adaptation compared to static and default configuration in terms of end-to-end latency (E2E delay) and packet loss rate (Pkt Loss). Notably, the performance improvement becomes evident as the offered load approaches to the network saturation point (e.g., number of CBR connections is 5).

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A method for optimizing a wireless network, the method comprising:
obtaining local measurement and feedback data from a single node in the wireless network;
estimating a state of the node by using the local measurement and feedback data in an analysis framework model of the wireless network;
applying the estimated state of the node to a local control law to determine one or more local protocol parameter updates for the node; and
transmitting the one or more local protocol parameter updates to the node in the wireless network.

2. The method of claim 1, further comprising:
obtaining global measurement and feedback data from one or more additional nodes in the wireless network;
estimating a state of the one or more additional nodes by using the global measurement and feedback data in the analysis framework model;
applying the estimated state of the one or more additional nodes to the local control law;
applying the estimated state of the one or more additional nodes to a global control law to determine one or more network-wide protocol parameter updates; and
transmitting the network-wide protocol parameter updates to the wireless network.

3. The method of claim 1, wherein the local measurement and feedback data comprises one or more of bit error rate, MAC losses, buffer losses, buffer drops, throughput on a path, throughput across a node, latency on a path, or latency across a node.

4. The method of claim 1, wherein the local measurement and feedback data lack communication overhead.

5. The method of claim 2, wherein the one or more additional nodes are not more than two hops from the single node.

6. The method of claim 1, wherein the analysis framework model computes the performance impact of a MAC layer and a network layer in the wireless network.

7. The method of claim 1, wherein the local protocol parameter updates provide for maximizing throughput while minimizing latency, or preserving throughput and latency.

8. The method of claim 2, wherein the network-wide protocol parameter updates provide for capacity maximization and loss minimization in the wireless network.

9. The method of claim 1, wherein the wireless network is an IEEE 802.11 network.

10. A computer program product comprising:
a non-transitory computer readable medium having instructions stored thereon executable by a processor to perform a method of optimizing a wireless network, the method comprising:
obtaining local measurement and feedback data from a single node in the wireless network;
estimating a state of the node by using the local measurement and feedback data in an analysis framework model of the wireless network;
applying the estimated state of the node to a local control law to determine one or more local protocol parameter updates for the node;
transmitting the one or more local protocol parameter updates to the node in the wireless network;
obtaining global measurement and feedback data from one or more additional nodes in the wireless network;
estimating a state of the one or more additional nodes by using the global measurement and feedback data in the analysis framework model;
applying the estimated state of the one or more additional nodes to the local control law;
applying the estimated state of the one or more additional nodes to a global control law to determine one or more network-wide protocol parameter updates; and
transmitting the network-wide protocol parameter updates to the wireless network.

11. A system for optimization of a wireless network, the system comprising:
a processor; and
a memory device operatively coupled to the processor, the memory device including processor readable instructions executable by the processor to run:
a first state estimator module comprising an analytic framework model of the wireless network, the first state estimator module configured to receive local measurements from a node in the wireless network;
a second state estimator module comprising the analytic framework model, the second state estimator module configured to receive global measurements from the wireless network;
a local control law module configured to receive input data from the first and second state estimator modules, and configured to output local protocol parameter updates to the wireless network; and
a global control law module configured to receive input data from the second state estimator module, and configured to output network-wide protocol parameter updates to the wireless network.

12. The system of claim 11, wherein the analytic framework model combines network queuing and interference.

13. The system of claim 11, wherein the local measurements comprise one or more of bit error rate, MAC losses, buffer losses, buffer drops, throughput on a path, throughput across a node, latency on a path, or latency across a node.

14. The system of claim 11, wherein the analytic framework model computes the performance impact of a MAC layer and a network layer in the wireless network.

15. The system of claim 11, wherein the local protocol parameter updates provide for maximizing throughput while minimizing latency, or preserving throughput and latency.

16. The system of claim 11, wherein the network-wide protocol parameter updates provide for capacity maximization and loss minimization in the wireless network.

17. The system of claim 11, wherein the wireless network is an IEEE 802.11 network.
